(19) United States
(12) Patent Application Publication
(10) Pub. No.: US 2018/0104803 A1
(43) Pub. Date: Apr. 19, 2018

(54) Bicycle Repair Tool

(71) Applicant: Louis Chuang, Taichung (TW)

(72) Inventor: Louis Chuang, Taichung (TW)

(21) Appl. No.: 15/631,011

(22) Filed: Jun. 23, 2017

(30) Foreign Application Priority Data
Oct. 18, 2016 (TW) 105133606

(51) Int. Cl. B25B 27/00; B25F 1/04; B25B 13/48; B25B 13/56; B25B 15/00

(52) U.S. Cl. CPC B25B 27/0071; B25F 1/04; B25B 13/481; B25F 1/00; B25B 15/005; B25B 15/008; B25B 13/48; B25B 13/56

(57) ABSTRACT

A bicycle repair tool includes a base, a first tool assembly, a second tool assembly, and a third tool assembly. The base includes a connecting portion, a first plate portion, a second plate portion, and a protruded portion. The connecting portion includes a receiving space. The protruded portion is connected to the first plate portion and is received in the receiving space. The first tool assembly is pivotally connected to a first side of the base and is located between the first and second plate portions. The second tool assembly is pivotally connected to a second side of the base and is located between the first and second plate portions. The connecting portion is located between the first and second tool assemblies. The third tool assembly is receivable in the receiving space and includes a tool including a receiving hole removably connected to the protruded portion.

### BACKGROUND OF THE INVENTION

The present invention relates to a repair tool and, particularly, to a repair tool for use in the maintenance and repair of bicycle components.

Taiwan Invention Patent No.I241970 discloses a tool assembly for a bicycle, which includes an I-shaped base and various hand tools mounted on two ends of the I-shaped base. The I-shaped base includes a substrate and two insertion bars penetrating through two ends of the substrate to form an I-shaped configuration.

However, the volume of the tool assembly is decided by the volume of the I-shaped base, but to restrict the number of the various hand tools, so that the tool assembly cannot meet various maintenance requirements while riding.

The present invention is, therefore, intended to obviate or at least alleviate the problems encountered in the prior art.

### BRIEF SUMMARY OF THE INVENTION

A bicycle repair tool includes a base, a first tool assembly, a second tool assembly, and a third tool assembly. The base includes a connecting portion, a first plate portion, a second plate portion, and a protruded portion. The connecting portion is connected between the first and second plate portions and includes a receiving space. The protruded portion is connected to the first plate portion and is received in the receiving space. The protruded portion is extended towards the second plate portion. The first tool assembly is pivotally connected to a first side of the base and is located between the first and second plate portions. The second tool assembly is pivotally connected to a second side of the base and is located between the first and second plate portions. The connecting portion is located between the first and second tool assemblies. The third tool assembly is receivable in the receiving space and includes a tool including a receiving hole removably connected to the protruded portion.

The present invention will become clearer in light of the following detailed description of illustrative embodiments of this invention described in connection with the drawings.

### DESCRIPTION OF THE DRAWINGS

FIG. 1 is a perspective view of a bicycle repair tool of a first embodiment according to the present invention.

FIG. 2 is an exploded perspective view of the bicycle repair tool of FIG. 1.

FIG. 3 is a cross-section view of the bicycle repair tool of FIG. 1.

FIG. 4 is another cross-section view of the bicycle repair tool of FIG. 1.

FIG. 5 is a perspective view of a bicycle repair tool of a second embodiment according to the present invention.

FIG. 6 is an exploded perspective view of the bicycle repair tool of FIG. 5.

FIG. 7 is a cross-section view of the bicycle repair tool of FIG. 5

FIG. 8 is another cross-section view of the bicycle repair tool of FIG. 5.

FIG. 9 is further another cross-section view of the bicycle repair tool of FIG. 5.

### DETAILED DESCRIPTION OF THE INVENTION

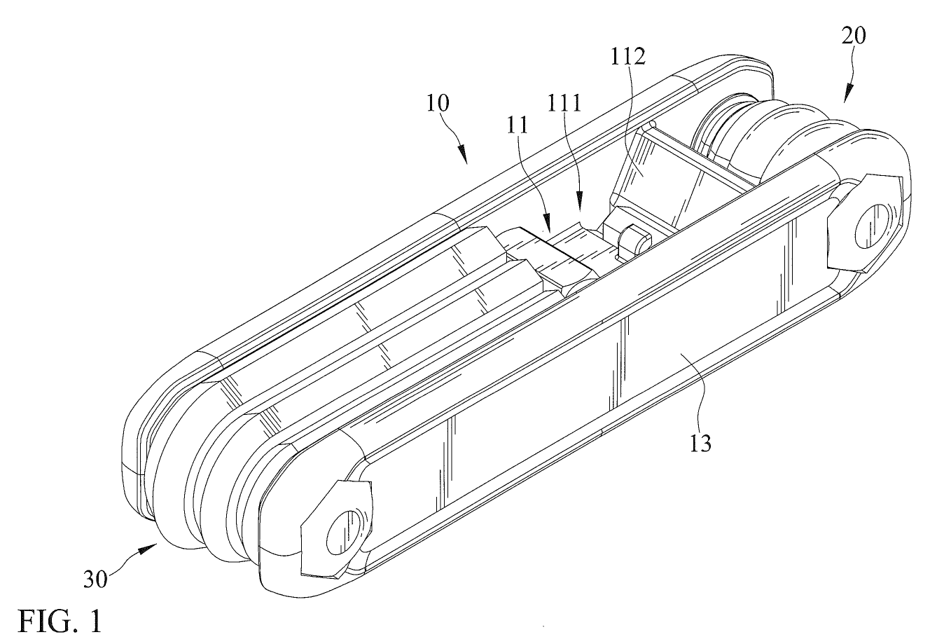

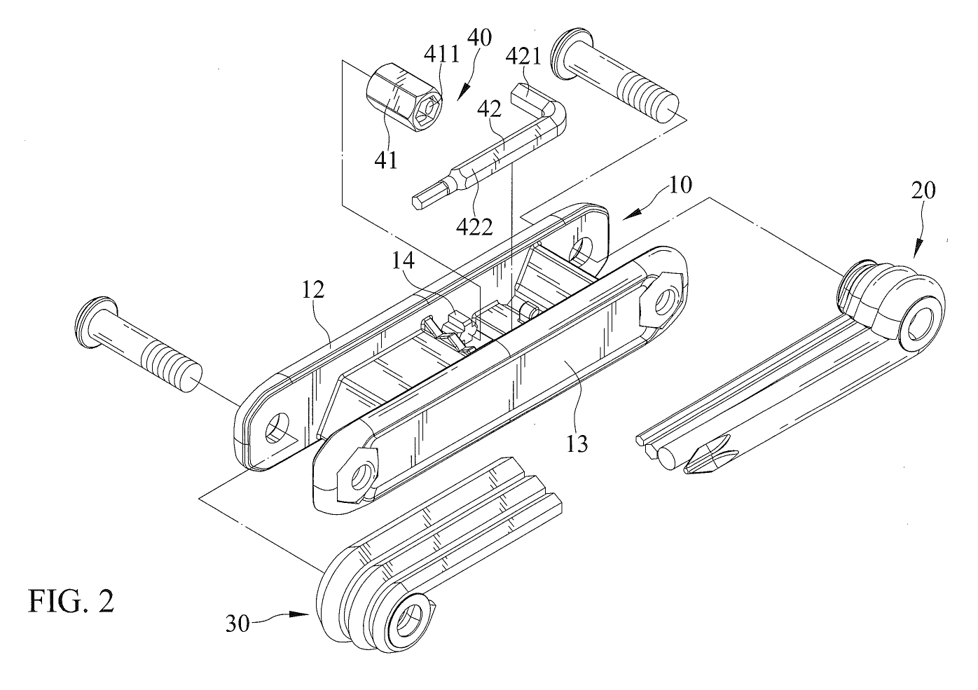

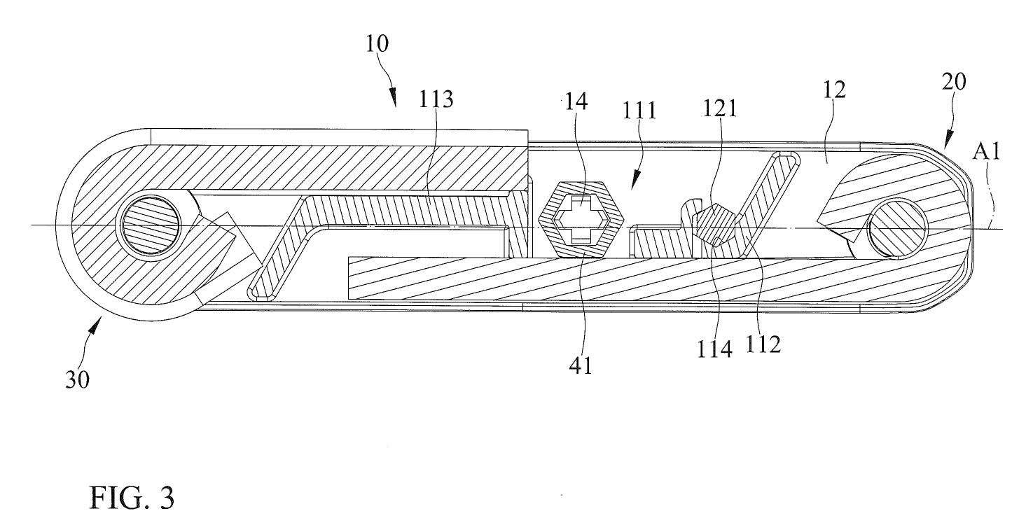

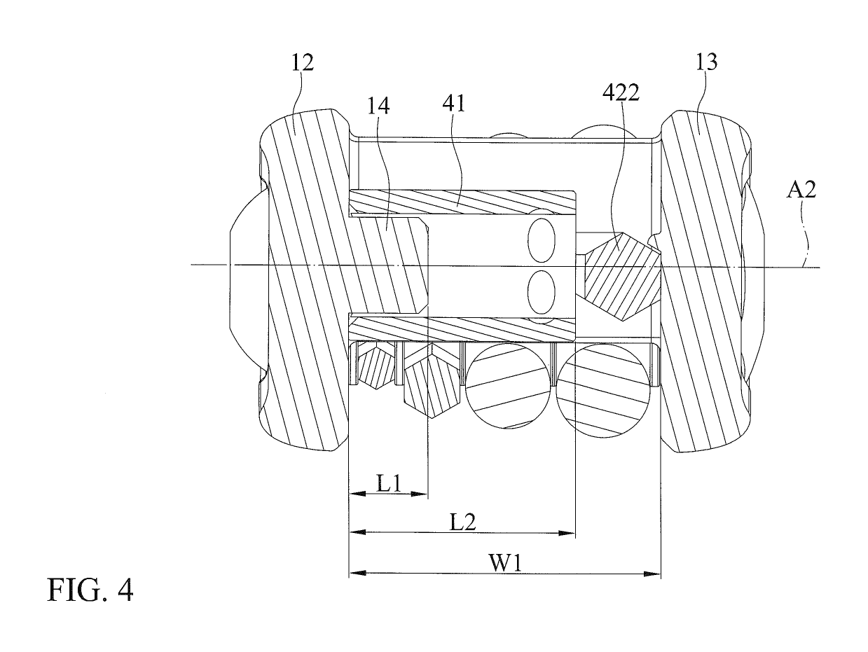

FIGS. 1-4 show a bicycle repair tool of a first embodiment according to the present invention. The bicycle repair tool includes a base 10, a first tool assembly 20 pivotally connected to a first side of base 10, a second tool assembly 30 pivotally connected to a second side of base 10, and a third tool assembly 40 detachably received in base 10 and located between first and second tool assemblies 20 and 30.

Base 10 includes a connecting portion 11, a first plate portion 12, a second plate portion 13, and at least one protruded portion 14. Connecting portion 11 is located and connected between first and second plate portions 12 and 13. Connecting portion 11 is located between first and second tool assemblies 20 and 30. First and second tool assemblies 20 and 30 are respectively located between first and second plate portions 12 and 13. Protruded portion 14 is connected to first plate portion 12 and is extended towards second plate portion 13. In the embodiment, first plate portion 12 is extended along a first straight line A1. Second plate portion 13 is parallel to first plate portion 12. The number of protruded portion 14 is one, and protruded portion 14 is extended along a second straight line A2 perpendicular to first straight line A1. Protruded portion 14 has a first length L1 along second straight line A2. A first width W1 is defined between first and second plate portions 12 and 13.

Connecting portion 11 includes a receiving space 111, a first section 112 connected to first plate portion 12, and a second section 113 connected to second plate portion 13. Receiving space 111 is located between first and second sections 112 and 113. Protruded portion 14 is received in receiving space 111. First section 112 is disposed adjacent to first tool assembly 20. Second section 113 is disposed adjacent to second tool assembly 30. In the embodiment, connecting portion 11 includes a positioning recess 114 disposed at first section 112 and adjacent to receiving space 111.

Third tool assembly 40 is receivable in receiving space 111 and includes at least one tool 41. Tool 41 includes a receiving hole 411 removably connected to protruded portion 14. Tool 41 may be a socket or a tool-bit. In the embodiment, the number of tool 41 is one and has a second length L2 along second straight line A2. First width W1 is greater than the sum of first and second lengths L1 and L2. Third tool assembly 40 further includes a wrench 42 detachably engaged with positioning recess 114 and received in receiving space 111.

Wrench 42 includes a first extending section 421 and a second extending section 422. First extending section 421 is perpendicularly connected to second extending section 422. First extending section 421 is detachably engaged with positioning recess 114. Second extending section 422 is located between tool 41 and second plate portion 13.

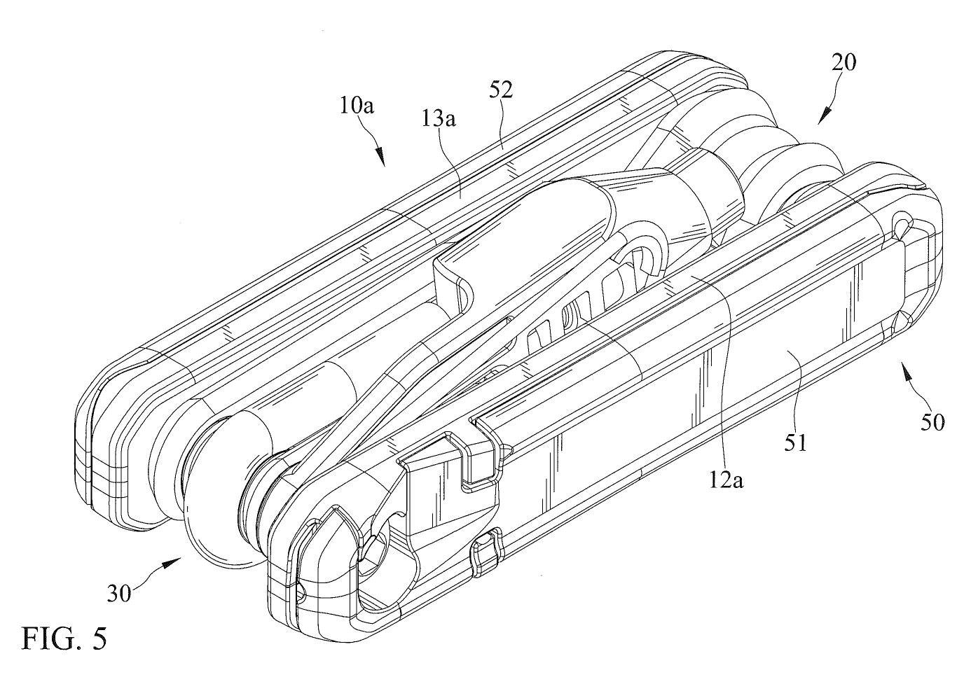

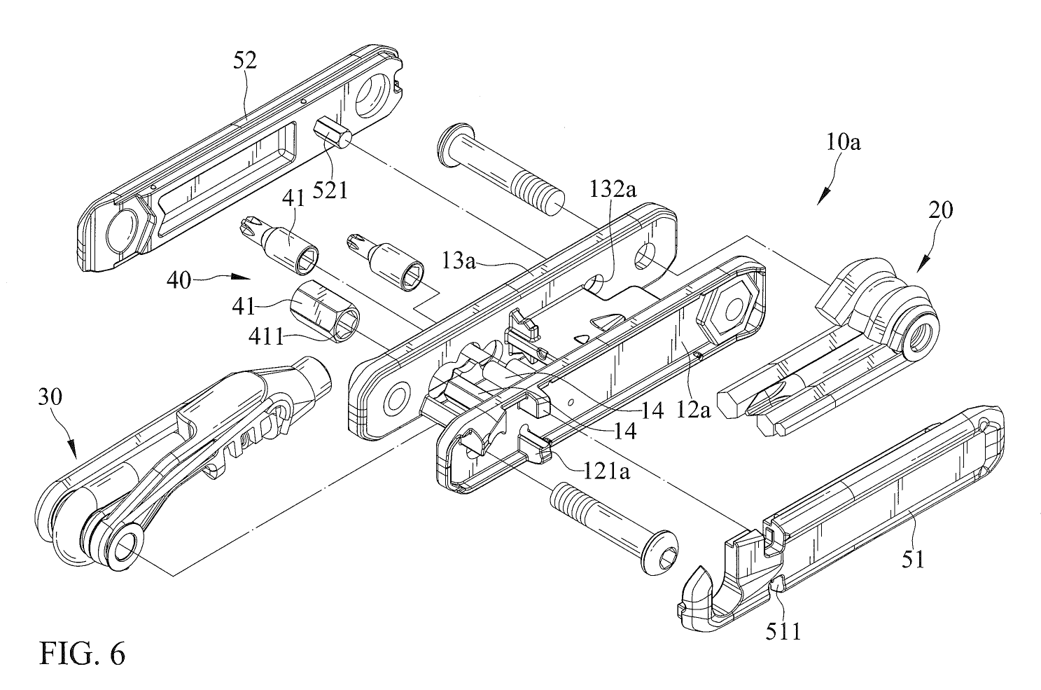

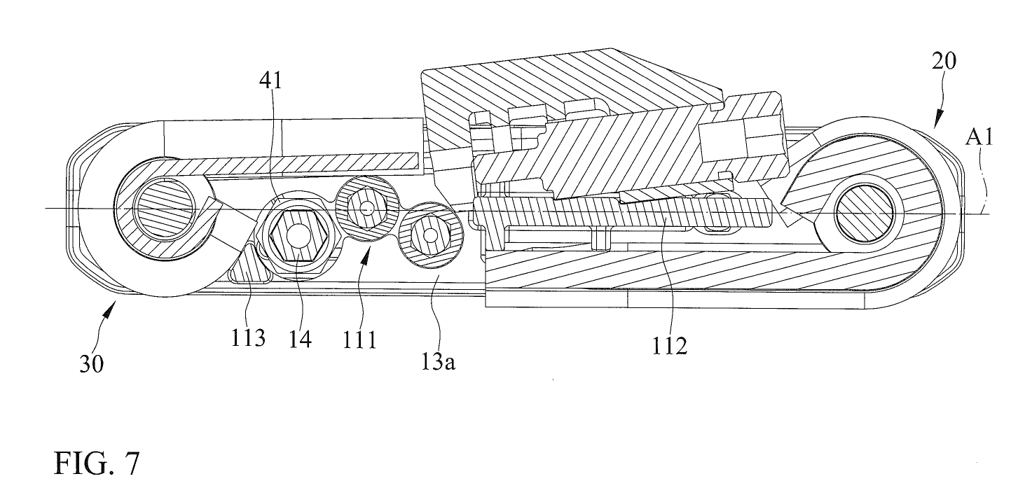

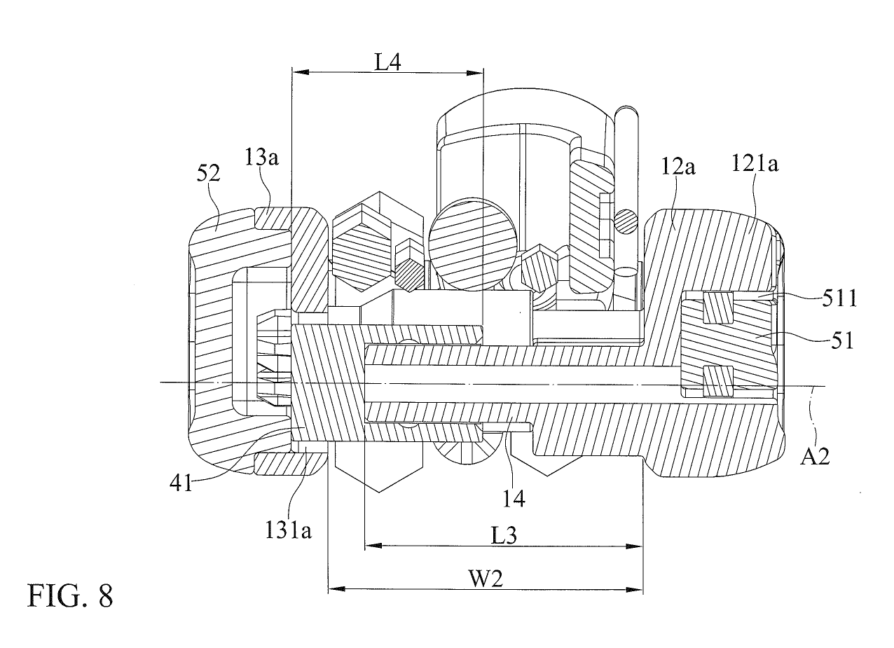

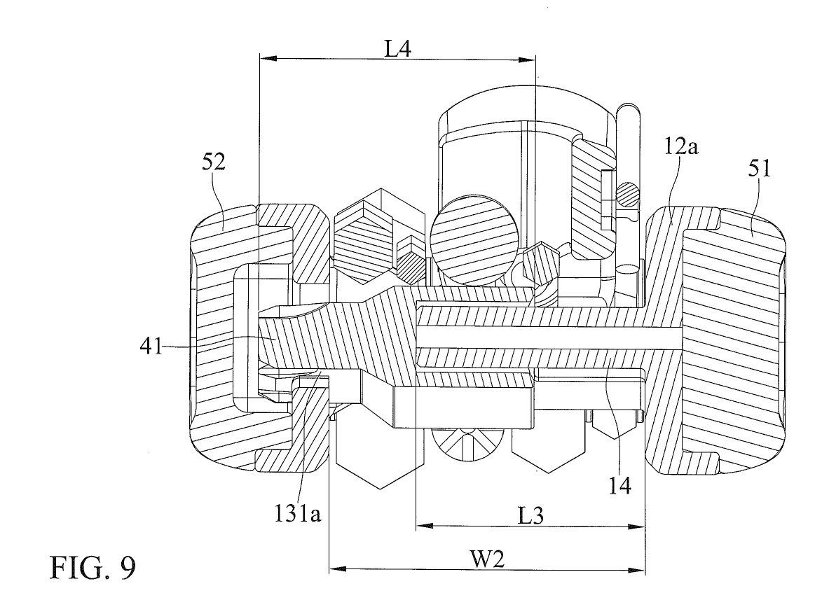

FIGS. 5-9 show a bicycle repair tool of a second embodiment according to the present invention substantially the same as the first embodiment except for base 10a. Specifically, first plate portion 12a of base 10a includes at least one positioning buckle 121a disposed at a side of first plate portion 12a opposite to second plate portion 13a. Second plate portion 13a includes an opening 131a and a receiving hole 132a. Opening 131a and receiving hole 132a are extended along second straight line A2 to penetrate through two opposite sides of second plate portion 13a. Opening 131a is interconnected to receiving space 111. Receiving hole 132a is disposed adjacent to a side of first section 112 opposite to receiving space 111. The number of protruded portions 14 is three, and the three protruded portions 14 are extended towards opening 131a. The number of tools 41 is three, and receiving holes 411 of the three tools 31 are respectively removably connected to the three protruded portions 14. The three tools 41 are receivable in opening 131a. The three tools 41 may be sockets or tool-bits.

In the embodiment, protruded portion 14 has a third length L3 along second straight line A2. Tool 41 has a fourth length L4 extended along second straight line A2. A second width W2 is defined between first and second plate portions 12a and 13a. Second width W2 is less than the sum of third and fourth lengths L3 and L4.

The bicycle repair tool of the second embodiment further includes a fourth tool assembly 50. Fourth tool assembly 50 includes a first tire lever 51 and a second tire lever 52. First tire lever 51 is detachably mounted on a side of first plate portion 12a opposite to second plate portion 13a. Second tire lever 52 is detachably mounted on a side of second plate portion 13a opposite to first plate portion 12a and covers opening 131a.

First tire lever 51 includes at least one receiving recess 511, and positioning buckle 121a is receivable in receiving recess 511. In the embodiment, the number of positioning buckles 121a is two, and the number of receiving recesses 511 is two. Second tire lever 52 includes a protrusion 521 receivable in receiving hole 132a.

The bicycle repair tool of the present invention exhibits advantages as follows:

1. Receiving space 111 is located between first and second tool assemblies 20 and 30, and third tool assembly is received in receiving space 111 to cause the volume of base 10; 10a able to be reduced. Thus, the bicycle repair tool of the present invention can receive various tools as possible to meet various maintenance requirements while riding.

2. First width W1 is greater than the sum of first and second lengths L1 and L2. Thus, when third tool assembly 40 is received in receiving space 111 of base 10, receiving hole 411 of tool 41 is connected to protruded portion 14. Second extending section 422 is located between tool 41 and second plate portion 13. Third tool assembly 40 is securely received in receiving space 111 of base 10.

3. Second width W2 is less than the sum of third and fourth lengths L3 and L4. Thus, when third tool assembly 40 is received in receiving space 111 of base 10a, receiving hole 411 of tool 41 is connected to protruded portion 14. Tool 41 is received in opening 131a. Fourth tool assembly 50 is mounted on base 10a to cause second tire lever 52 covering opening 131a. Third tool assembly 40 is securely received in receiving space 111 of base 10a.

Although specific embodiments have been illustrated and described, numerous modifications and variations are still possible without departing from the scope of the invention. The scope of the invention is limited by the accompanying claims.

1. A bicycle repair tool comprising:
a base including a connecting portion, a first plate portion, a second plate portion, and at least one protruded portion, with the connecting portion connected between the first and second plate portions, with the connecting portion including a receiving space, with the at least one protruded portion connected to the first plate portion and received in the receiving space, with the at least one protruded portion extended towards the second plate portion;
a first tool assembly pivotally connected to a first side of the base and located between the first and second plate portions;
a second tool assembly pivotally connected to a second side of the base and located between the first and second plate portions, with the connecting portion located between the first and second tool assemblies; and
a third tool assembly receivable in the receiving space and including at least one tool, with the at least one tool including a receiving hole removably connected to the at least one protruded portion.

2. The bicycle repair tool as claimed in claim 1, with the first plate portion extended along a first straight line, with the second plate portion parallel to the first plate portion, and with the at least one protruded portion extended along a second straight line perpendicular to the first straight line.

3. The bicycle repair tool as claimed in claim 2, with the at least one protruded portion having a first length along the second straight line, with the at least one tool having a second length along the second straight line, and with a first width defined between the first and second plate portions and greater than the sum of the first and second lengths.

4. The bicycle repair tool as claimed in claim 2, with the second plate portion including an opening extended along the second straight line to penetrate through two opposite sides of the second plate portion and interconnected to the receiving space, with the at least one tool receivable in the opening.

5. The bicycle repair tool as claimed in claim 4, with the at least one protruded portion having a third length along the second straight line, with the at least one tool having a fourth length extended along the second straight line, and with a second width defined between the first and second plate portions and less than the sum of the third and fourth lengths.

6. The bicycle repair tool as claimed in claim 3, with the connecting portion including a positioning recess disposed at an end of the connecting portion adjacent to the receiving space, and with the third tool assembly including a wrench detachably engaged with the positioning recess and received in the receiving space.

7. The bicycle repair tool as claimed in claim 6, with the wrench including a first extending section and a second extending section, with the first extending section perpendicularly connected to the second extending section, with the first extending section detachably engaged with the positioning recess, and with the second extending section located between the at least one tool and the second plate portion.

8. The bicycle repair tool as claimed in claim 4, further comprising:
a fourth tool assembly including a first tire lever and a second tire lever, with the first tire lever detachably mounted on a side of the first plate portion opposite to the second plate portion, and with the second tire lever detachably mounted on a side of the second plate portion opposite to the first plate portion and covering the opening.

9. The bicycle repair tool as claimed in claim 8, with the first plate portion including at least one positioning buckle, with the second plate portion including a receiving hole penetrating through two opposite sides of the second plate portion, with the first tire lever including at least one receiving recess, with the at least one positioning buckle receivable in the at least one receiving recess to detachably mount the first tire lever on the first plate portion, and with the second tire lever including a protrusion receivable in the receiving hole to detachably mount the second tire lever on the second plate portion.

10. The bicycle repair tool as claimed in claim 1, with the connecting portion including a first section connected to the first plate portion and a second section connected to the second plate portion, with the receiving space disposed between the first and second sections, with the first section disposed adjacent to the first tool assembly, and with the second section disposed adjacent to the second tool assembly
